(19) United States
(12) Patent Application Publication
(10) Pub. No.: US 2024/0006939 A1
(43) Pub. Date: Jan. 4, 2024

(54) BRUSHLESS DC MOTOR

(71) Applicants: Mohammad Reza Nakhaei Amroudi, Kerman (IR); Mitra Mirhosseini, Kerman (IR); Alireza Karbakhsh Ravari, Kerman (IR)

(72) Inventors: Mohammad Reza Nakhaei Amroudi, Kerman (IR); Mitra Mirhosseini, Kerman (IR); Alireza Karbakhsh Ravari, Kerman (IR)

(73) Assignees: Mohammad Reza Nakhaei Amroudi, Kerman, OT (IR); Mitra Mirhosseini, Kerman, OT (IR); Alireza Karbakhsh Ravari, Kerman, OT (IR); Electricity distribution company in the north of Kerman province, Kerman, OT (IR); Shahid Bahonar Kerman University, Kerman, OT (IR)

(21) Appl. No.: 18/468,723

(22) Filed: Sep. 17, 2023

Related U.S. Application Data
(63) Continuation-in-part of application No. PCT/IB2021/060787, filed on Nov. 21, 2021.
(60) Provisional application No. 63/162,045, filed on Mar. 17, 2021.

(51) Int. Cl. H02K 1/279; H02K 11/33; H02K 11/21

(52) U.S. Cl. CPC H02K 1/279; H02K 11/33; H02K 11/21; H02K 2213/03

(57) ABSTRACT

A brushless DC motor may include an annular rotor including a plurality of annular sectors. Each exemplary annular sector includes a respective array of permanent magnets embedded in and equally spaced circumferentially around each respective annular sector. The motor may further include an annular stator coaxially disposed within the annular rotor. An exemplary annular stator may include a plurality of coils mounted on and equally spaced circumferentially around the annular stator, where each coil may be energized with a current based at least in part on the rotor position. The motor may further include a position sensor that may generate an output signal indicative of the rotational position of the annular rotor, and a controller that may be configured to receive the output signal from the position sensor and utilize a power source to energize each coil of the plurality of coils based on the received output signal.

### CROSS-REFERENCE TO RELATED APPLICATION

This application is a continuation-in-part of PCT/IB2021/060787 filed Nov. 21, 2021, and entitled “BRUSHLESS DC MOTOR” which claims the benefit of priority from U.S. Provisional Patent Application Ser. No. 63/162,045, filed on Mar. 17, 2021, and entitled “OPTIMIZED BRUSHLESS DC MOTOR WITH FOUR PULSES,” which both are incorporated herein by reference in their entirety.

### TECHNICAL FIELD

The present disclosure relates to brushless DC motors and particularly to an optimized brushless DC motor with four pulses.

### BACKGROUND

A brushless DC motor may generally include a rotor and a stator. The rotor may include an output shaft and a central hub that may be coupled to the output shaft. The rotor may further include a number of permanent magnets embedded in the central hub of the rotor. A stator of a brushless DC motor may include a number of windings. The rotor may either coaxially enclose or be enclosed by the stator. In practice, an electronic controller may be utilized to send DC current pulses to the windings of the stator to generate rotating magnetic fields for the permanent magnets of the rotor to follow.

A brushless DC motor is widely used in various applications due to advantages, such as higher efficiency, higher speed range, lower acoustic noise, durability, simplicity, and lightness. Furthermore, brushless DC motors benefit from a greater dynamic response and better speed versus torque characteristics. Brushless DC motors may find application in home appliances, aerospace and automated industrial equipment.

In a brushless DC motor, the controller is an electronic commutator in contrast with brushed DC motors, where brushes are utilized as mechanical commutators. An electronic commentator of a brushless DC motor continually switches the phase to the windings of the stator to keep the brushless DC motor turning. An electronic commentator of a brushless DC motor may further adjust the phase and amplitude of the DC current pulses.

As the number of permanent magnets of the rotor increases, a larger number of current pulses must be utilized. However, with an increase in the number of pulses, the dead-band time in one cycle of the current pulses increases, as well. Such increase in the dead-band time in one cycle may result in lower maximum achievable speed in a brushless DC motor. Therefore, there is a need for designing a brushless DC motor that may allow for increasing the speed without the need to increase the number of current pulses.

### SUMMARY

This summary is intended to provide an overview of the subject matter of the present disclosure and is not intended to identify essential elements or key elements of the subject matter, nor is it intended to be used to determine the scope of the claimed implementations. The proper scope of the present disclosure may be ascertained from the claims set forth below in view of the detailed description and the drawings.

According to one or more exemplary embodiments, the present disclosure is directed to a brushless DC motor. An exemplary motor may include an annular rotor including a plurality of annular sectors. Each exemplary annular sector of the plurality of annular sectors may include a respective array of permanent magnets embedded in and equally spaced circumferentially around each respective annular sector. Orientation of magnetization direction of each permanent magnet of the respective array of permanent magnets with respect to a radius of the annular rotor passing through a center point of each permanent magnet may be determined by:

$${A}_{i} = ( i - 1 ) \times \frac{90 °}{{N}_{m}}$$

In the equation above, Aᵢ may denote the orientation of the magnetization direction of i^{th} permanent magnet in each respective array of permanent magnets and N m denotes the number of permanent magnets in each respective array of permanent magnets within each annular sector of the plurality of annular sectors, and 1≤i≤Nₘ.

An exemplary motor may further include an annular stator coaxially disposed within the annular rotor. An exemplary annular stator may include a plurality of coils mounted on and equally spaced circumferentially around the annular stator, where each coil of the plurality of coils may be configured to be energized with a current based at least in part on the rotor position. An exemplary motor may further include a position sensor that may be configured to generate an output signal indicative of the rotational position of the annular rotor, and a controller that may be coupled to the position sensor and the plurality of coils, the controller configured to receive the output signal from the position sensor and utilize a power source to energize each coil of the plurality of coils based at least in part on the received output signal.

### BRIEF DESCRIPTION OF THE DRAWINGS

The novel features which are believed to be characteristic of the present disclosure, as to its structure, organization, use and method of operation, together with further objectives and advantages thereof, will be better understood from the following drawings in which a presently exemplary embodiment of the present disclosure will now be illustrated by way of example. It is expressly understood, however, that the drawings are for illustration and description only and are not intended as a definition of the limits of the present disclosure. Embodiments of the present disclosure will now be described by way of example in association with the accompanying drawings in which:

FIG. 1A illustrates a brushless DC motor, consistent with one or more exemplary embodiments of the present disclosure;

FIG. 1B illustrates a top view of an array of permanent magnets within an annular sector, consistent with one or more exemplary embodiments of the present disclosure;

FIG. 2A illustrates a perspective view and a top view of a block/bar/cube permanent magnet, consistent with one or more exemplary embodiments of the present disclosure;

FIG. 2B illustrates a perspective view and a top view of a disc/cylinder permanent magnet, consistent with one or more exemplary embodiments of the present disclosure; and

FIG. 2C illustrates a perspective view and a top view of a ring/tube permanent magnet, consistent with one or more exemplary embodiments of the present disclosure.

### DETAILED DESCRIPTION

The novel features which are believed to be characteristic of the present disclosure, as to its structure, organization, use and method of operation, together with further objectives and advantages thereof, will be better understood from the following discussion.

The present disclosure is directed to exemplary embodiments of an outrunner brushless DC motor, where a rotor of the brushless DC motor is located on the outside of a stator of the brushless DC motor. An exemplary brushless DC motor may include an annular rotor that may be coupled to a motor shaft. A plane of an exemplary annular rotor may be perpendicular to a longitudinal axis of an exemplary motor shaft. An exemplary brushless DC motor may further include an annular stator mounted coaxially within an exemplary annular rotor. A plane of an exemplary annular stator may be parallel with a plane of rotation of an exemplary annular rotor.

An exemplary annular rotor may include a plurality of arrays of permanent magnets that may be mounted on or embedded in an outer periphery of an exemplary annular rotor. An exemplary annular surface of an exemplary annular rotor may be divided into a plurality of similar annular sectors and each respective array of the plurality of arrays of permanent magnets may be mounted on or embedded into each respective annular sector. Magnetization direction of an i^{th} permanent magnet in a given array of Nₘ permanent magnets may be oriented with respect to a radius of an exemplary annular rotor passing through a center point of the i^{th} permanent magnet at an angle equal to (i-1) 90°/Nₘ. In other words, permanent magnets within an array of permanent magnets are not all oriented radially on an exemplary annular rotor and the orientation of the magnetization direction of each permanent magnet with respect to a radius of an exemplary annular rotor is different from an adjacent permanent magnet of the array or permanent magnets.

Exemplary permanent magnets of each array of permanent magnets are generally oriented such that similar poles of exemplary permanent magnets may face a center of an exemplary annular rotor. Furthermore, arrays of permanent magnets are alternately oriented around a periphery of an exemplary annular rotor such that adjacent arrays of permanent magnets may face the center of an exemplary annular rotor with different poles.

An exemplary stator of an exemplary brushless DC motor may include a number of coils, the number of which corresponds to the number of arrays of permanent magnets mounted on an exemplary annular rotor. Each coil of exemplary coils of an exemplary stator may be energized at any given moment based on the rotational position of an exemplary annular rotor such that each coil and a corresponding array of permanent magnets may face each other with similar poles. As used herein, a corresponding array of permanent magnets may refer to an array of permanent magnets positioned in front of a given coil. To this end, a position sensor may be utilized to determine and transmit the rotational position of an exemplary rotor. An exemplary brushless DC motor may further include a controller that may utilize the position feedback received from an exemplary position sensor to energize exemplary coils of an exemplary stator accordingly.

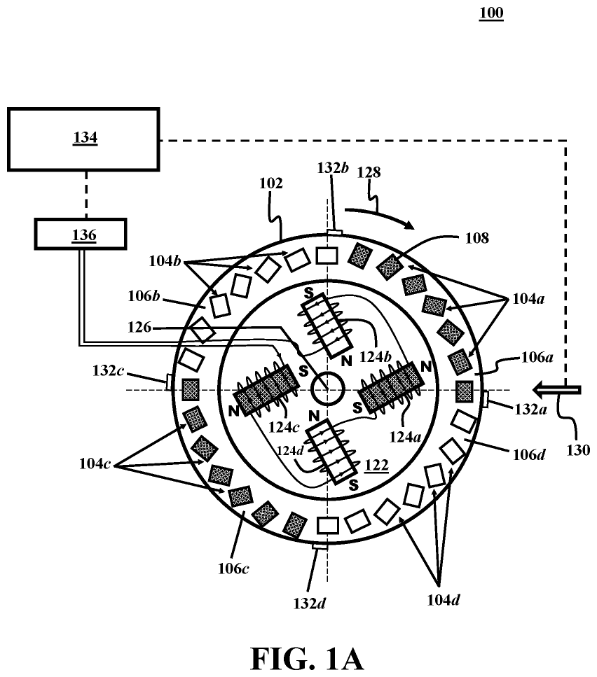

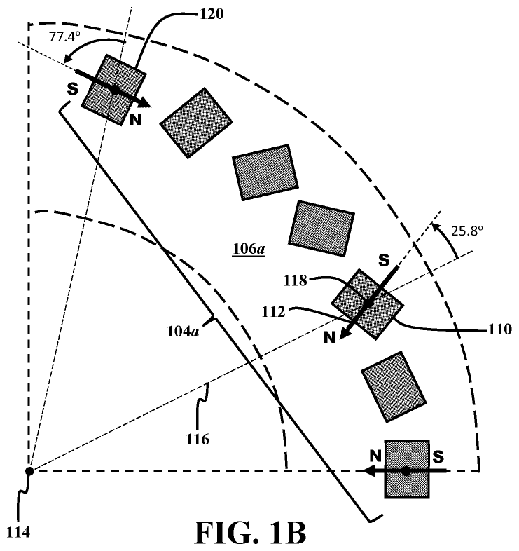

FIG. 1A illustrates a brushless DC motor 100, consistent with one or more exemplary embodiments of the present disclosure. In an exemplary embodiment, brushless DC motor 100 may include an annular rotor 102 and a plurality of arrays of permanent magnets (104a-104d) that may be embedded into or mounted on annular rotor 102. In an exemplary embodiment, an annular surface of annular rotor 102 that may lie on a plane of rotation of annular rotor 102 may be divided into a plurality of annular sectors (106a-106d). In an exemplary embodiment, plurality of annular sectors 104 may include annular sectors with similar angles and equal surface areas. For example, the annular surface of annular rotor 102 may be divided into four annular sectors of 90° angle, such as plurality of annular sectors (106a-106d) as shown in FIG. 1A. As used herein, an annular sector may refer to an annular portion of the annular surface of annular rotor 102, which may be bordered by two straight lines (for understanding) from a center of the annular surface of annular rotor 102 and an arc of a certain angle.

In an exemplary embodiment, each array of permanent magnets of plurality of arrays of permanent magnets (104a-104d) may be embedded in or mounted on a respective annular sector of plurality of annular sectors (106a-106d). In an exemplary embodiment, permanent magnets of each array of permanent magnets may be equally spaced circumferentially around each respective annular sector of plurality of annular sectors (106a-106d). For example, a first array of permanent magnets 104a may be embedded in or mounted on a first annular sector 106a of annular rotor 102, and permanent magnets of first array of permanent magnets 104a may be equally spaced circumferentially around first annular sector 106a. Similarly, a second array of permanent magnets 104b may be embedded in or mounted on a second annular sector 106b of annular rotor 102, and permanent magnets of second array of permanent magnets 104b may be equally spaced circumferentially around second annular sector 106b. Similarly, a third array of permanent magnets 104c may be embedded in or mounted on a third annular sector 106c of annular rotor 102, and permanent magnets of third array of permanent magnets 104c may be equally spaced circumferentially around third annular sector 106c. Similarly, a fourth array of permanent magnets 104d may be embedded in or mounted on a fourth annular sector 106d of annular rotor 102, and permanent magnets of fourth array of permanent magnets 104d may be equally spaced circumferentially around fourth annular sector 106d.

In an exemplary embodiment, respective permanent magnets of each array of permanent magnets of plurality of arrays of permanent magnets (104a-104d) may be structurally similar. In an exemplary embodiment, each permanent magnet of each array of permanent magnets, such as permanent magnet 108 of first array of permanent magnets 104a may include one of a disc/cylinder permanent magnet, a ring/tube permanent magnet, and a block/bar/cube magnet. In an exemplary embodiment, plurality of arrays of permanent magnets (104a-104d) may include permanent magnets, such as sintered neodymium magnets that have undergone single-pole magnetization. Magnetization direction of each permanent magnet of plurality of arrays of permanent magnets (104a-104d) based on the particular shape of each permanent magnet is further discussed below.

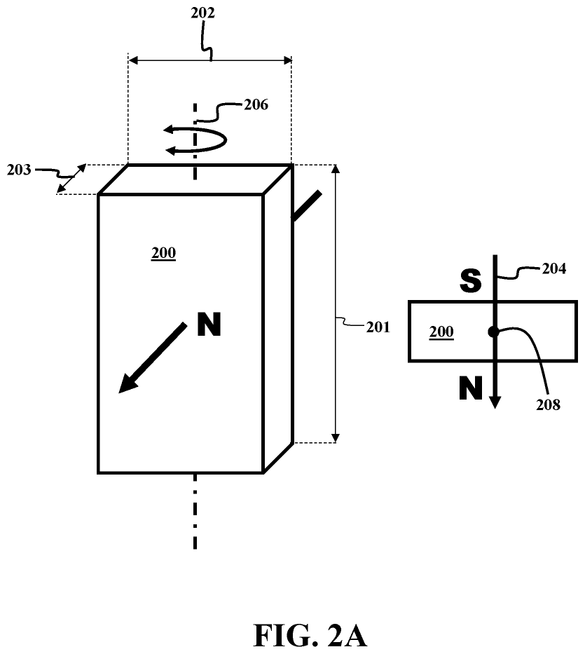

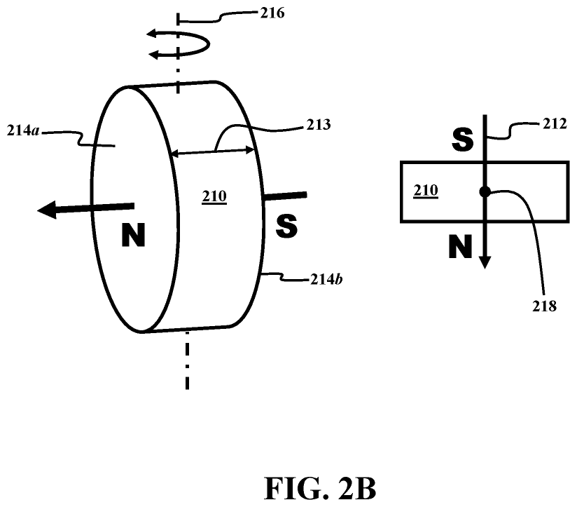

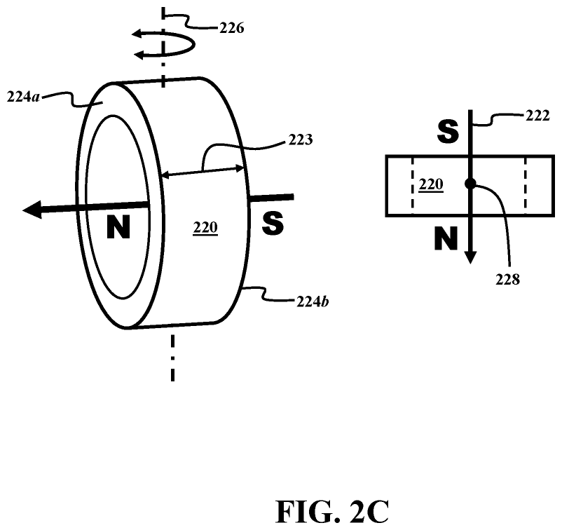

FIG. 2A illustrates a perspective view and a top view of a block/bar/cube permanent magnet 200, consistent with one or more exemplary embodiments of the present disclosure. FIG. 2B illustrates a perspective view and a top view of a disc/cylinder permanent magnet 210, consistent with one or more exemplary embodiments of the present disclosure. FIG. 2C illustrates a perspective view and a top view of a ring/tube permanent magnet 220, consistent with one or more exemplary embodiments of the present disclosure.

Referring to FIG. 2A, in an exemplary embodiment, each permanent magnet of plurality of arrays of permanent magnets (104a-104d) may be a block/bar/cube permanent magnet, such as block/bar/cube permanent magnet 200. In an exemplary embodiment, block/bar/cube permanent magnet 200 may have a length 201, a width 202, and a thickness 203. In an exemplary embodiment, block/bar/cube permanent magnet 200 may be magnetized through thickness 203 along a magnetization direction shown by arrow 204. In an exemplary embodiment, orientation of the magnetization direction is fixed relative to block/bar/cube permanent magnet 200 and may not be changed once block/bar/cube permanent magnet 200 is made. In an exemplary embodiment, block/bar/cube permanent magnet 200 may be rotated about a central axis of rotation 206. In an exemplary embodiment, central axis of rotation 206 may be extended along length 201 of block/bar/cube permanent magnet 200 passing through a center point 208 of block/bar/cube permanent magnet 200. In an exemplary embodiment, center point 208 of block/bar/cube permanent magnet 200 may be superimposed on a midpoint between the two poles of block/bar/cube permanent magnet 200. In an exemplary embodiment, in response to block/bar/cube permanent magnet 200 rotating about central axis of rotation 206, the magnetization direction of block/bar/cube permanent magnet 200 shown by arrow 204 may rotate about central axis of rotation 206, as well.

Referring to FIG. 2B, in an exemplary embodiment, each permanent magnet of plurality of arrays of permanent magnets (104a-104d) may be a disc/cylinder permanent magnet, such as disc/cylinder permanent magnet 210. In an exemplary embodiment, disc/cylinder permanent magnet 210 may be axially magnetized along a magnetization direction shown by arrow 212. An axially magnetized disc/cylinder permanent magnet, such as disc/cylinder permanent magnet 210 may be magnetized along a height 213 of disc/cylinder permanent magnet 210, such that the north and south poles may be located on flat, circular faces 214a and 214b of disc/cylinder permanent magnet 210. In an exemplary embodiment, orientation of the magnetization direction is fixed relative to disc/cylinder permanent magnet 210 and may not be changed once disc/cylinder permanent magnet 210 is made. In an exemplary embodiment, disc/cylinder permanent magnet 210 may be rotated about a central axis of rotation 216. In an exemplary embodiment, central axis of rotation 216 may be extended along a radius of disc/cylinder permanent magnet 210 passing through a center point 218 of disc/cylinder permanent magnet 210. In an exemplary embodiment, center point 218 of disc/cylinder permanent magnet 210 may be superimposed on a midpoint between the two poles of disc/cylinder permanent magnet 210. In an exemplary embodiment, in response to disc/cylinder permanent magnet 210 rotating about central axis of rotation 216, the magnetization direction of disc/cylinder permanent magnet 210 shown by arrow 212 may rotate about central axis of rotation 216, as well.

Referring to FIG. 2C, in an exemplary embodiment, each permanent magnet of plurality of arrays of permanent magnets (104a-104d) may be a ring/tube permanent magnet, such as ring/tube permanent magnet 220. In an exemplary embodiment, ring/tube permanent magnet 220 may be axially magnetized along a magnetization direction shown by arrow 222. An axially magnetized disc/cylinder permanent magnet, such as ring/tube permanent magnet 220 may be magnetized along a height 223 of ring/tube permanent magnet 220, such that the north and south poles may be located on flat, annular faces 224a and 224b of ring/tube permanent magnet 220. In an exemplary embodiment, orientation of the magnetization direction is fixed relative to ring/tube permanent magnet 220 and may not be changed once ring/tube permanent magnet 220 is made. In an exemplary embodiment, ring/tube permanent magnet 220 may be rotated about a central axis of rotation 226. In an exemplary embodiment, central axis of rotation 226 may be extended along a radius of ring/tube permanent magnet 220 passing through a center point 228 of ring/tube permanent magnet 220. In an exemplary embodiment, center point 228 of ring/tube permanent magnet 220 may be superimposed on a midpoint between the two poles of ring/tube permanent magnet 220. In an exemplary embodiment, in response to ring/tube permanent magnet 220 rotating about central axis of rotation 226, the magnetization direction of ring/tube permanent magnet 220 shown by arrow 222 may rotate about central axis of rotation 216, as well.

In an exemplary embodiment, each permanent magnet of plurality of arrays of permanent magnets (104a-104d) may be embedded in or mounted on annular rotor 102 such that a respective magnetization direction of each permanent magnet may be parallel with the plane of rotation of annular rotor 102 and a respective central axis of rotation of each permanent magnet may be perpendicular to the plane of rotation of annular rotor 102. For example, each permanent magnet of plurality of arrays of permanent magnets (104a-104d) may include a permanent magnets similar to block/bar/cube permanent magnet 200 that may be embedded in or mounted on annular rotor 102, such that the magnetization direction of block/bar/cube permanent magnet 200 shown by arrow 204 may be parallel with the plane of rotation of annular rotor 102 and central axis of rotation 206 of block/bar/cube permanent magnet 200 may be perpendicular to the plane of rotation of annular rotor 102. Similarly, each permanent magnet of plurality of arrays of permanent magnets (104a-104d) may include a permanent magnets similar to disc/cylinder permanent magnet 210 that may be embedded in or mounted on annular rotor 102, such that the magnetization direction of disc/cylinder permanent magnet 210 shown by arrow 212 may be parallel with the plane of rotation of annular rotor 102 and central axis of rotation 216 of disc/cylinder permanent magnet 210 may be perpendicular to the plane of rotation of annular rotor 102. Similarly, each permanent magnet of plurality of arrays of permanent magnets (104a-104d) may include a permanent magnets similar to ring/tube permanent magnet 220 that may be embedded in or mounted on annular rotor 102, such that the magnetization direction of ring/tube permanent magnet 220 shown by arrow 222 may be parallel with the plane of rotation of annular rotor 102 and central axis of rotation 226 of ring/tube permanent magnet 220 may be perpendicular to the plane of rotation of annular rotor 102. As used herein, magnetization direction may refer to direction of north-south polarization of each permanent magnet and the magnetization direction may further refer to a direction from south pole of each permanent magnet towards a north pole of each permanent magnet.

FIG. 1B illustrates a top view of array of permanent magnets 104a within annular sector 106a, consistent with one or more exemplary embodiments of the present disclosure. In an exemplary embodiment, an annular surface of an annular rotor may be divided into Nₛ annular sectors with equal surface areas and equal angles of 360/Nₛ. For example, the annular surface of annular rotor 102 may be divided into four annular sectors (106a-106d) with equal angles of 90°. In an exemplary embodiment, each array of permanent magnets within each annular sector may include Nₘ permanent magnets equally spaced circumferentially around each annular sector. In an exemplary embodiment, orientation of the magnetization direction of each permanent magnet with respect to a radius of an annular rotor passing through a center point of each permanent magnet may be determined by equation (1) below:

$${A}_{i} = ( i - 1 ) \times \frac{90 °}{{N}_{m}} \qquad Equation ( 1 )$$

In equation (1) above, A denotes the orientation of the magnetization direction of i^{th} permanent magnet in each array of permanent magnets and N m denotes the number of permanent magnets in each array of permanent magnets within each annular sector of the plurality of annular sectors, and 1≤i≤Nₘ. For example, magnetization direction of permanent magnet 110 of first array of permanent magnets 104a is shown by arrow 112, where a north pole N of permanent magnet 110 is located towards a center 114 of annular rotor 102. In an exemplary embodiment, orientation of the magnetization direction of permanent magnet 110 may be defined herein as an angle between arrow 112 and a radius 116 of annular rotor 102 passing through a center point 118 of permanent magnet 110. According to equation (1) above, since first array of permanent magnets 104a includes 7 permanent magnets, A or orientation of the magnetization direction of i^{th} permanent magnet in first array of permanent magnets 104a may be equal to (i-1)×12.9°. Consequently, orientation of magnetization direction of permanent magnet 110, which is the third permanent magnet in first array of permanent magnets 104a may be equal to 25.8°. In other words, the magnetization direction of permanent magnet 110 (shown by arrow 112) may make an angle of 25.8° with radius 116. it should be noted that permanent magnets within an exemplary array of permanent magnets are numbered in a counterclockwise direction. For example, permanent magnet 110 is the third permanent magnet in first array of permanent magnets 104a and permanent magnet 120 may be the seventh permanent magnet within first array of permanent magnets 104a. Consequently, orientation of the magnetization direction of permanent magnet 120 may be 77.4°.

In an exemplary embodiment, responsive to the surface of annular rotor 102 being divided into four 90° ann8ular sectors, an angular distance between center points of permanent magnets within an array of permanent magnets may be equal to 90°/Nₘ. For example, the angular distance between each pair of neighboring permanent magnets of first array of permanent magnets 104a may be equal to 12.9°.

In an exemplary embodiment, in each section of the plurality of annular sections of an exemplary annular rotor, permanent magnets may be oriented such that permanent magnets may face an exemplary center point of an exemplary annular rotor with similar polarities (N or S). For example, permanent magnets of first array of permanent magnets 104a may be oriented such that the permanent magnets may face center point 114 with respective north (N) poles of the permanent magnets. Consequently, first array of permanent magnets 104a may provide a north (N) polarity in first annular sector 106a.

In an exemplary embodiment, neighboring annular sectors of plurality of annular sectors of an exemplary annular rotor may have opposite polarities. For example, first array of permanent magnets 104a may provide a north (N) polarity in first annular sector 106a as discussed in the previous paragraph, second array of permanent magnets 104b may provide a south (S) polarity in second annular sector 106b, third array of permanent magnets 104c may provide a north (N) polarity in third annular sector 106c as discussed in the previous paragraph, fourth array of permanent magnets 104d may provide a south (S) polarity in fourth annular sector 106d. In other words, every other annular section of plurality of annular sectors (106a-106d) may have similar polarities.

In an exemplary embodiment, second array of permanent magnets 104b providing a south (S) polarity in second annular sector 106b may refer to an arrangement of permanent magnets within second array of permanent magnets 104b, where permanent magnets may face center point 114 with their respective south (S) poles. In an exemplary embodiment, third array of permanent magnets 104c providing a north (N) polarity in third annular sector 106c may refer to an arrangement of permanent magnets within third array of permanent magnets 104c, where permanent magnets may face center point 114 with their respective north (N) poles. In an exemplary embodiment, fourth array of permanent magnets 104d providing a south (S) polarity in fourth annular sector 106d may refer to an arrangement of permanent magnets within fourth array of permanent magnets 104d, where permanent magnets may face center point 114 with their respective south (S) poles. Referring to FIG. 1A, two different polarities of N and S are distinguished by shaded and white permanent magnets to show the arrangement where neighboring annular sectors have different polarities of N or S.

In an exemplary embodiment, brushless DC motor 100 may further include an annular stator 122 that may be coaxially mounted within annular rotor 102. In an exemplary embodiment, annular stator 122 may refer to a stator with a ring-like or cylindrical shape. n an exemplary embodiment, annular stator 122 may lie on a plane parallel with the plane of rotation of annular rotor 102. In an exemplary embodiment, annular stator 122 may include a plurality of coils (124a, 124d) that may be mounted on or embedded in annular stator 122. In an exemplary embodiment, plurality of coils (124a-124d) may be equally spaced circumferentially around annular stator 122. In an exemplary embodiment, number of coils mounted on or embedded in an exemplary annular stator corresponds to the number of exemplary arrays of permanent magnets mounted on or embedded in annular sectors of an exemplary annular rotor. For example, since annular rotor 102 is divided into four annular sectors (106a-106d) and includes four arrays of permanent magnets (104a-104d), annular stator 122 may correspondingly include four coils (124a-124d).

In an exemplary embodiment, exemplary coils of an exemplary annular stator may be positioned such that their respective north-south polarities may have an offset of 360°/Nₛ with respect to neighboring coils. For example, when Nₛ=4, four coils (124a-124d) may be positioned with 90° offsets with respect to each other, such that at any given instant during the operation of brushless DC motor 100, each coil of four coils (124a-124d) may be positioned in each annular sector of plurality of annular sectors (106a-106d) in front of each corresponding array of plurality of arrays of permanent magnets (104a-104d). For example, in the instant illustrated in FIG. 1A, coil 124a is positioned in first annular sector 106a in front of first array of permanent magnets 104a, coil 124b is positioned in second annular sector 106b in front of second array of permanent magnets 104b, coil 124c is positioned in third annular sector 106c in front of third array of permanent magnets 104c, and coil 124d is positioned in fourth annular sector 106d in front of fourth array of permanent magnets 104d.

In an exemplary embodiment, each coil of plurality of coils (124a-124d) may be configured to be energized with a current based at least in part on angular position of annular rotor 102. In an exemplary embodiment, plurality of coils (124a-124d) may be configured to be energized such that similar poles of each coil of plurality of coils (124a-124d) and each corresponding array of plurality of arrays of permanent magnets (104a-104d) may face each other when current is being applied. For example, in the instant illustrated in FIG. 1A, coil 124a is positioned in front of first array of permanent magnets 104a such that north (N) pole of coil 124a may face north (N) poles of permanent magnets of first array of permanent magnets 104a, coil 124b is positioned in front of second array of permanent magnets 104b such that south (S) pole of coil 124b may face south (S) poles of permanent magnets of second array of permanent magnets 104b, coil 124c is positioned in front of third array of permanent magnets 104c such that north (N) pole of coil 124c may face north (N) poles of permanent magnets of third array of permanent magnets 104c, and coil 124d is positioned in front of fourth array of permanent magnets 104d such that south (S) pole of coil 124d may face south (S) poles of permanent magnets of fourth array of permanent magnets 104d. To this end, each coil of plurality of coils (124a-124d) may be configured to have a north-south polarization oriented with an offset of 360°/Nₛ with respect to neighboring coils of the plurality of coils. For example, coil 124b is configured to have a north-south polarity with an offset of 90° relative to coil 124a and coil 124c, that is, based on its structural properties. The offset of 90° may refer to an arrangement where coil 124b is rotated about a normal axis of annular stator 122 passing through ha center point of coil 124b by 90° in a clockwise manner with respect to coil 124a.

In an exemplary embodiment, as annular rotor 102 rotates about normal central axis 126 (perpendicular to view) of annular rotor 102 in a direction shown by arrow 128, direction of current applied to each coil of plurality of coils (124a-124d) may be changed based on which array of permanent magnets is positioned in front of each coil. In an exemplary embodiment, brushless DC motor 100 may further include a position sensor (not illustrated but its elements are) that may be configured to generate an output signal indicative of the angular position of annular rotor 102 about normal central axis 126. In an exemplary embodiment, position sensor may be a position sensor that may be configured to sense positions as apparent by the further explanation of sensing element 130 below. In an exemplary embodiment, the position sensor may include a sensing element 130 that may be mounted adjacent annular rotor 102 and a plurality of sensible elements (132a-132d) that may be mounted on annular rotor 102. In an exemplary embodiment, number of exemplary sensible elements may correspond to the number of arrays of permanent magnets mounted on exemplary plurality of annular sectors of an exemplary annular rotor. In an exemplary embodiment, each sensible element of the plurality of sensible elements (132a-132d) may be mounted on annular rotor 102 at a position corresponding to the position of the first permanent magnet of each array of permanent magnets. For example, sensible element 132a may be mounted adjacent the first permanent magnet of first array of permanent magnets 104a and marks the beginning of first annular sector 106a, sensible element 132b may be mounted adjacent the first permanent magnet of second array of permanent magnets 104b and marks the beginning of second annular sector 106b, sensible element 132c may be mounted adjacent the first permanent magnet of third array of permanent magnets 104c and marks the beginning of third annular sector 106b, and sensible element 132d may be mounted adjacent the first permanent magnet of fourth array of permanent magnets 104d and marks the beginning of fourth annular sector 106d.

In an exemplary embodiment, sensing element 130 may be mounted independent from annular rotor 102, that is, sensing element 130 may not assume any rotational or translational movements with annular rotor 102, while sensible elements (132a-132d) may be rotatable with annular rotor 102 about normal central axis 126. Consequently, sensing element 130 may be configured to generate an output signal indicative of each sensible element of sensible elements (132a-132d) passing in front of sensing element 130.

In an exemplary embodiment, sensing element 130 may be configured to generate a signal indicative of the beginning of each respective annular sector of plurality of annular sectors responsive to sensing element 132 sensing each respective sensible element of plurality of sensible elements (132a-132d). In an exemplary embodiment, sensing element 130 may be an optical sensor and sensible elements (132a-132d) may include optical tags that can be read or sensed by sensing element 130.

In an exemplary embodiment, brushless DC motor 100 may further include a controller 134 that may be coupled to sensing element 130 and plurality of coils (124a-124d). In an exemplary embodiment, controller 134 may be configured to receive the output signal from sensing element 130. In an exemplary embodiment, controller 134 may further be configured to urge a driver 136 to energize each coil of plurality of coils (124a-124d) based at least in part on the received output signal from sensing element 130.

In other words, controller 134 may utilize rotor position feedback to determine when to switch the current applied to plurality of coils (124a-124d). In an exemplary embodiment, rotor position feedback may be provided by sensing element 120 and switching the current direction may be possible by utilizing driver 136. In an exemplary embodiment, responsive to a change in the current applied to plurality of coils (124a-124d), respective polarity of each coil of plurality of coils may change (124a-124d), such that each coil of plurality of coils (124a-124d) and a respective array of plurality of arrays of permanent magnets (104a-104d) may always face each other with similar poles. Consequently, annular rotor 102 may be urged to rotate about central normal axis 126 under the influence of repulsion force between of plurality of coils (124a, 124d) and corresponding plurality of arrays of permanent magnets (104a-104d).

In an exemplary embodiment, such arrangement of exemplary permanent magnets of annular rotor 102 and how the magnetization directions of the exemplary permanent magnets are individually oriented may allow for utilizing a lower number of current pulses. For example, for annular rotor 102 with four arrays of permanent magnets (104a-104d), only 4 electric pulses may be provided by controller 134 to plurality of coils (124a, 124d), since the poles of plurality of coils (124a, 124d) only needs to change four times. In other words, in an exemplary brushless DC motor, one electric pulse is needed for each array of permanent magnets, while in a conventional brushless DC motor one electric pulse is required for each permanent magnet.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for description and not of limitation, such that the terminology or phraseology of the present specification is to be interpreted by the skilled artisan in light of the teachings and guidance.

The breadth and scope of the present disclosure should not be limited by any of the above-described exemplary embodiments but should be defined only in accordance with the following claims and their equivalents.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

Moreover, the word “substantially” when used with an adjective or adverb is intended to enhance the scope of the particular characteristic, e.g., substantially planar is intended to mean planar, nearly planar and/or exhibiting characteristics associated with a planar element. Further use of relative terms such as “vertical”, “horizontal”, “up”, “down”, and “side-to-side” are used in a relative sense to the normal orientation of the apparatus.

What is claimed is:

1. A brushless DC motor, comprising:
an annular rotor comprising a plurality of annular sectors, each annular sector of the plurality of annular sectors comprising a respective array of permanent magnets embedded in and equally spaced circumferentially around each respective annular sector, orientation of magnetization direction of each permanent magnet of the respective array of permanent magnets with respect to a radius of the annular rotor passing through a center point of each permanent magnet determined by:
$${A}_{i} = ( i - 1 ) \times \frac{90 °}{{N}_{m}}$$
wherein, Aᵢ denotes the orientation of the magnetization direction of it h permanent magnet in each respective array of permanent magnets and N m denotes the number of permanent magnets in each respective array of permanent magnets within each annular sector of the plurality of annular sectors, and 1≤i≤Nₘ;
an annular stator coaxially disposed within the annular rotor, the annular stator comprising a plurality of coils mounted on and equally spaced circumferentially around the annular stator, each coil of the plurality of coils configured to be energized with a current based at least in part on the rotor position;
a position sensor configured to generate an output signal indicative of the rotational position of the annular rotor; and
a controller coupled to the position sensor and the plurality of coils, the controller configured to receive the output signal from the position sensor and utilize a power source to energize each coil of the plurality of coils based at least in part on the received output signal.

2. The brushless DC motor according to claim 1, wherein the center point of the i^{th} permanent magnet is superimposed on a center of a line connecting the two poles of the i^{th} permanent magnet.

3. The brushless DC motor according to claim 2, wherein the array of permeant magnets within each annular sector of the plurality of annular sectors have similar magnetization directions.

4. The brushless DC motor according to claim 3, wherein the magnetization directions of the array of permanent magnets within each annular sector of the plurality of annular sectors are opposite the magnetization directions of the array of permanent magnets within neighboring annular sectors.

5. The brushless DC motor according to claim 4, wherein the magnetization directions of permanent magnets within each respective array of permanent magnets are parallel with a plane of rotation of the annular rotor.

6. The brushless DC motor according to claim 5, wherein the controller is configured to energize each coil of the plurality of coils such that each coil and a corresponding array of permanent magnets in front of each coil face each other with similar poles.

7. The brushless DC motor according to claim 6, wherein number of coils mounted on the annular stator is equal to number of arrays of permanent magnets embedded in the annular rotor.

8. The brushless DC motor according to claim 7, wherein each coil of the plurality of coils comprises a north-south polarization oriented with an offset of 360°/Nₛ with respect to neighboring coils of the plurality of coils, wherein Nₛ denotes number of annular sectors.

9. The brushless DC motor according to claim 8, wherein each coil of the plurality of coils comprises a north-south polarization opposite north-south polarization of neighboring coils.

10. The brushless DC motor according to claim 9, wherein the position sensor comprises a sensing element mounted adjacent the annular rotor and a plurality of sensible elements mounted on the annular rotor, the sensing element configured to generate an output signal indicative of each sensible element passing in front of the sensing element.

11. The brushless DC motor according to claim 10, wherein the sensing element is fixed in position without any translational or rotational movements relative to the annular rotor, the sensible elements rotatable with the annular rotor about the central normal axis of the annular rotor.

12. The brushless DC motor according to claim 11, wherein each sensible element of the plurality of sensible elements mounted at a position corresponding to a position of the first permanent magnet of each respective array of permanent magnets.

13. The brushless DC motor according to claim 12, wherein the controller is further configured to change the north-south polarization of each coil of the plurality of coils responsive to receiving the output signal from the sensing element.

14. The brushless DC motor according to claim 13, wherein each array of permanent magnets within each respective annular sector of the annular rotor comprises a plurality of one of disc/cylinder permanent magnets, ring/tube permanent magnets, and block/bar/cube magnets.
